(19) United States
(12) Patent Application Publication
(10) Pub. No.: US 2012/0158990 A1
(43) Pub. Date: Jun. 21, 2012

(54) Transporting a CBR Data Stream Over a Packet Switched Network

(75) Inventors: Giacomo Losio, Tortona (AL) (IT); Federico Scandroglio, Cassano Magnago (VA) (IT); Gilberto Loprieno, Milano (IT); Luca Della Chiesa, Concorezzo (MI) (IT); Giovanni Giobbio, Rovellasca (CO) (IT)

(73) Assignee: CISCO TECHNOLOGY, INC., San Jose, CA (US)

(21) Appl. No.: 12/971,369

(22) Filed: Dec. 17, 2010

(51) Int. Cl. G06F 15/16

(52) U.S. Cl. 709/236

(57) ABSTRACT

In one embodiment a method includes receiving a constant bit rate data stream, segmenting the constant bit rate data stream into fixed size blocks of data, generating a time stamp indicative of a system reference clock, the time stamp being in reference to a clock rate of the constant bit rate data stream, encapsulating, in an electronic communication protocol frame, a predetermined number of fixed blocks of data along with (i) a control word indicative of, at least, a relative sequence of the predetermined number of fixed blocks of data in the constant bit rate stream and (ii) the time stamp, and transmitting the electronic communication protocol frame to a packet switched network.

### TECHNICAL FIELD

The present disclosure relates to transporting data, such as video data, over a packet switched network.

### BACKGROUND

Broadcasters, such as television broadcasters or other content providers, capture audiovisual content and then pass that content to, e.g., a production studio for distribution to end users. As is becoming more common, the audiovisual content is captured digitally, and is then passed to the production studio in a digital form. While ultimate end users may be provided with a compressed version of the digital audiovisual content for, e.g., their televisions or computer monitors, production engineers (and perhaps others) often desire a full, original, non-compressed version of the audiovisual data stream.

When a venue at which the audiovisual content is captured is distant from the production studio, the venue and production studio must be connected to each other via an electronic network to transfer the audiovisual content. The electronic network infrastructure may be public and is often some sort of time division multiplex (TDM) network, based on, e.g., Synchronous Optical Network (SONET) or Synchronous Digital Hierarchy (SDH) technology. Such network connectivity provides a “strong” link between two endpoints (and thus between the venue at which the audiovisual content is captured and the production studio) such that the full, original, audiovisual data stream can be transmitted without concern regarding timing and data loss. However, it is becoming increasingly desirable to employ packet switched networks (PSNs) for transmitting captured digital audiovisual data streams between endpoints. However, PSNs can present challenges for transmitting certain types of data streams.

### BRIEF DESCRIPTION OF THE DRAWINGS

FIG. 1 shows an example implementation of end to end connectivity between network endpoints wherein both endpoints of the network connection share a common system clock.

FIG. 2 shows an example implementation of end to end connectivity between network endpoints wherein the endpoints of the network connection do not share a common system clock.

FIG. 3 shows an example video data stream being segmented into fixed size blocks and having a control word added to each resulting block.

FIG. 4 shows a plurality of fixed size blocks being encapsulated within an Ethernet frame along with timing information.

FIG. 5 shows an arrangement via which a differential timing time stamp is added to each Ethernet frame at a sending or ingress node of a network connection.

FIG. 6 shows how the differential timing time stamp is used at a receiving or egress node of the network connection.

FIG. 7 shows an alternative approach to sending and receiving differential timing information.

FIG. 8 shows a sampling operation to obtain data to place in a bit 0 field of each fixed size block, wherein the data is employed at the egress node of the network connection to recreate a system reference clock.

FIG. 9 depicts example contents of the control word that is appended to each fixed size block.

FIG. 10 is a flowchart of an example series of steps for performing transmission of a constant bit rate data stream over a packet switched network.

FIG. 11 is a flowchart of an example series of steps for receiving and processing a constant bit rate data stream over a packet switched network.

### DESCRIPTION OF EXAMPLE EMBODIMENTS

### Overview

Embodiments described herein enable the convergence of a constant bit rate video distribution network and a packet switched network such as an Ethernet network. In one embodiment, a method includes, at an ingress node, receiving a constant bit rate data stream, segmenting the constant bit rate data stream into fixed size blocks of data, generating a time stamp indicative of a system reference clock, the time stamp being in reference to a clock rate of the constant bit rate data stream, encapsulating, in an electronic communication protocol frame, a predetermined number of fixed size blocks of data along with (i) a control word indicative of, at least, a relative sequence of the predetermined number of fixed blocks of data in the constant bit rate stream and (ii) the time stamp, and transmitting the electronic communication protocol frame to a packet switched network.

At an egress node, a method includes receiving, via the packet switched network, the electronic communication protocol frame, generating a slave clock that is controlled at least in part based on the time stamp, clocking out from memory the constant bit rate data stream data using the slave clock, and processing selected fixed blocks of constant bit rate data stream data using information from the control word.

### Example Embodiments

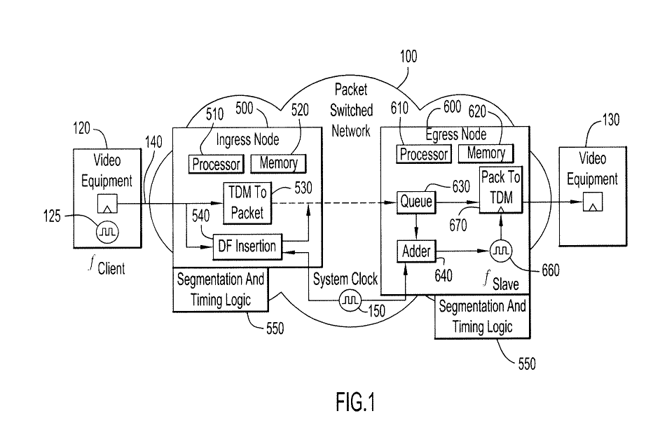

FIG. 1 depicts an example implementation of end to end connectivity between network endpoints wherein both endpoints of the network connection share a common system clock. More specifically, two endpoints 120, 130 each comprise video equipment and desire to share a video stream. Although the following description is with reference to data streaming from left to right in FIG. 1, those skilled in the art will appreciate that video equipment 130 may also be the source of a data stream, and thus the data stream may similarly flow from right to left in the drawing.

Endpoint 120 is shown having a client clock 125. The frequency or rate of clock 125 is the frequency at which a data stream 140, such as a constant bit rate (CBR) video stream, is clocked out of video equipment 120. As will be explained in detail, video equipment at endpoint 130 will ultimately receive the entire, uncompressed, version of video stream 140, even though the video stream will have transited a packet switched network 100.

As further shown, a system reference clock 150 is available to an ingress node 500 and an egress node 600 of the packet switched network 100. These nodes may be integral with respective endpoints 120, 130, or physically separated from those endpoints. The purpose of ingress node 500 is to receive CBR data stream 140 and to appropriately packetize the same for transmission via the packet switched network 100. The purpose of egress node 600 is to receive the output of ingress node 500 (via the packet switched network 100), and convert the packetized data back into a CBR data stream 140 for delivery to the video equipment within network endpoint 130.

Ingress node 500 and egress node 600 each include a processor 510, 610 and associated memory 520, 620. The memory 520, 620 may also comprise segmentation and timing logic 550, the function of which will be described more fully below. It is noted, preliminarily, that segmentation and timing logic 550 as well as other functionality of the ingress node 500 and egress node 600 may be implemented as one or more hardware components, one or more software components, or combinations thereof. More specifically, the processors 510, 610 used in conjunction with segmentation and timing logic 550 may be comprised of a programmable processor (microprocessor or microcontroller) or a fixed-logic processor. In the case of a programmable processor, any associated memory (e.g., 520, 620) may be of any type of tangible processor readable memory (e.g., random access, read-only, etc.) that is encoded with or stores instructions. Alternatively, the processors 510, 610 may be comprised of a fixed-logic processing device, such as an application specific integrated circuit (ASIC) or digital signal processor that is configured with firmware comprised of instructions or logic that cause the processor to perform the functions described herein. Thus, the segmentation and timing logic 550 may take any of a variety of forms, so as to be encoded in one or more tangible media for execution, such as with fixed logic or programmable logic (e.g., software/computer instructions executed by a processor) and any processor may be a programmable processor, programmable digital logic (e.g., field programmable gate array) or an ASIC that comprises fixed digital logic, or a combination thereof. In general, any process logic described herein may be embodied in a processor or computer readable medium that is encoded with instructions for execution by a processor that, when executed by the processor, are operable to cause the processor to perform the functions described herein.

Referring again to FIG. 1, ingress node 500 further comprises a time division multiplexing (TDM) to packet module 530 and differential timing (DF) insertion module 540, which will be described more fully below. Likewise, egress node 600 further comprises a queue 630 (which could be part of memory 620) that receives the packetized data via packet switched network 100, an adder block 640 that is used to control slave clock 660 and a packet to TDM module 670 that is clocked by slave clock 660 and that re-generates the CBR data stream 140 for delivery to video equipment 130.

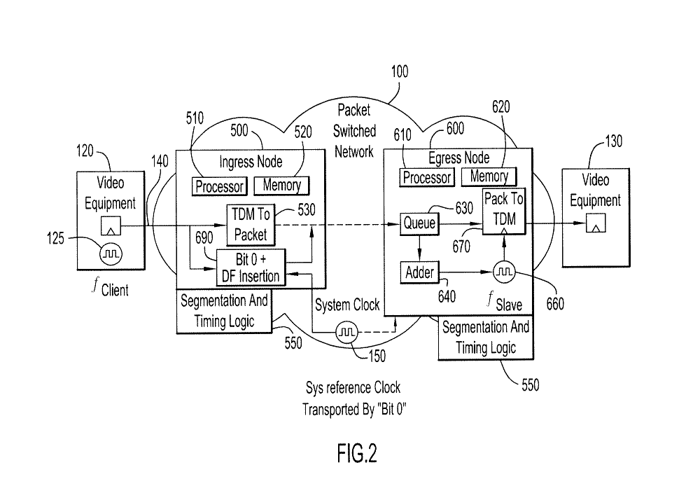

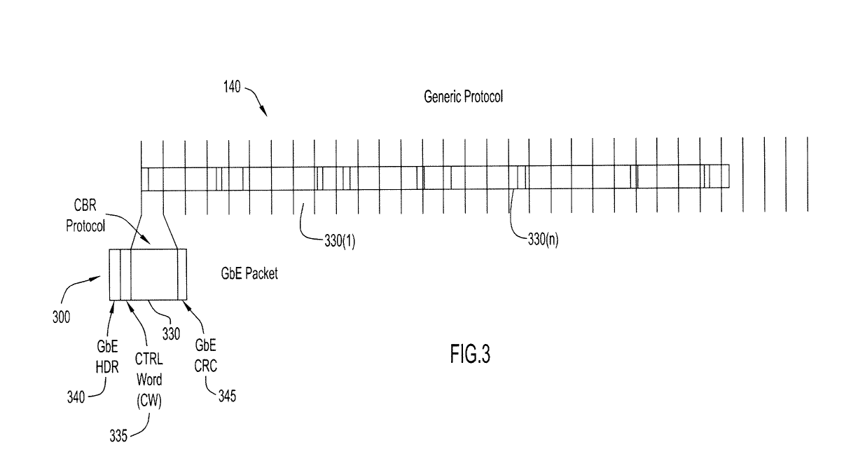

FIG. 2 shows an example implementation of end to end connectivity between network endpoints wherein the endpoints of the network connection do not share a common system clock. That is, in the embodiment of FIG. 2, system reference clock 150 is not known to egress node 600. Accordingly, to recreate or re-generate CBR data stream 140, a second embodiment described herein transmits the system reference clock information within a packetized version of the CBR data stream 140 that is output from ingress node 500. In this embodiment, DF insertion module 540 is replaced by a zero bit and DF insertion module 690. Details of both embodiments follow, first with reference to FIG. 3.

FIG. 3 shows an example CBR data stream 140 that is segmented into fixed size data blocks 330(1) . . . 330(n). The CBR data stream 140 may be any data stream, including a data stream that comprises high definition audiovisual data. As will become apparent to those skilled in the art, the CBR data stream 140 may be consistent with any protocol as the processing described herein is protocol agnostic.

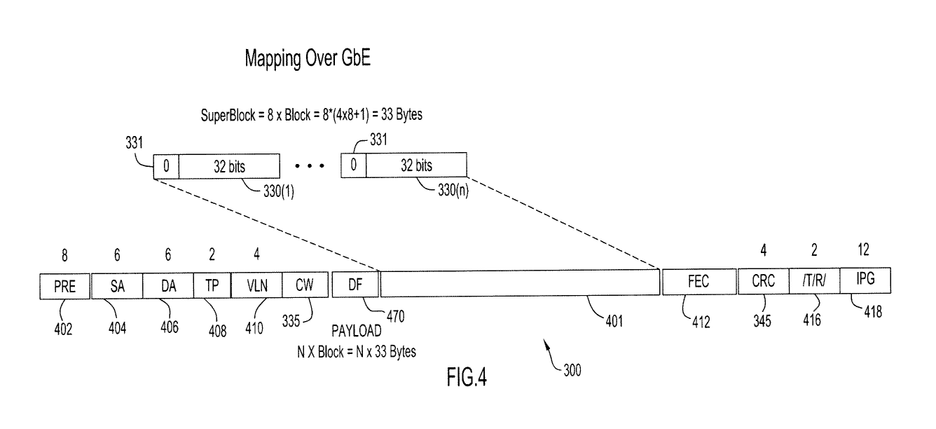

In accordance with a particular implementation, the video data stream 140 is segmented, chopped up, or otherwise grouped into individual data blocks 330(1) . . . 330(n) having a fixed size. This processing is performed by segmentation and timing logic 550 in conjunction with processor 510 and TDM to packet module 530. As shown in FIG. 4, and explained more fully below, each data block 330 may comprise 32 bits, along with an added “zero” bit 331 that is used for timing purposes (in the second embodiment), thus making each block 330 a total of 33 bits.

Referring still to FIG. 3, each fixed size data block 330 (or a predetermined number thereof as explained with reference to FIG. 4) is encapsulated in, e.g., an Ethernet frame 300 with a header 340 and Cyclical Redundancy Checking (CRC) 345 trailer that is appended, along with a control word 335 and (as shown in FIG. 4) a differential timing time stamp 470 that is generated by DF insertion module 540. More specifically, and as shown in FIG. 4, the Ethernet frame 300 comprises multiple fields including preamble 402, source address 404, destination address 406, type field 408, virtual local area network (VLAN) 410, forward error correction (FEC) 412, CRC 354, /T/R/field 416 and interpacket gap (IPG) field 418. The payload field 401 of the Ethernet packet 300 contains one or more fixed size data blocks 330 each with a respective zero bit 331, along with the control word 335 and differential timing time stamp 470.

In the implementation shown in FIG. 4, a super block of eight data blocks 330(1)-330(n), where n=8 in this case, is assembled together in a single Ethernet frame payload 401. Multiples of eight blocks may be selected in order to better conform to existing byte-size based processing schemes and protocols.

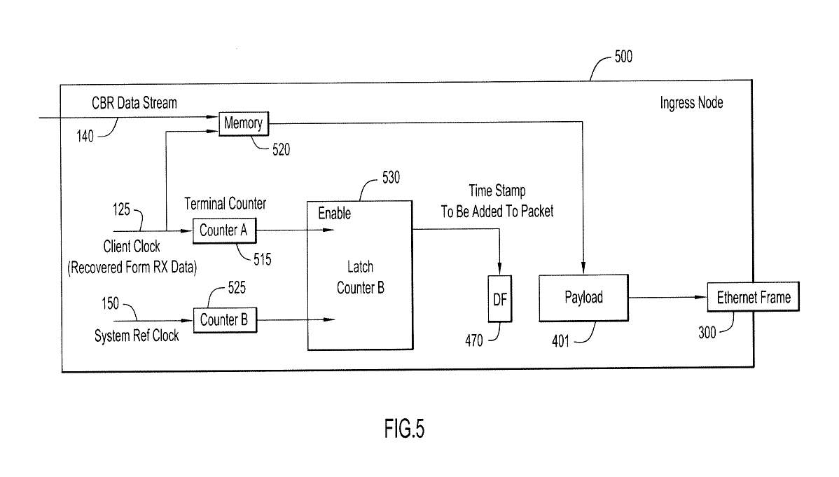

As mentioned, there are two possible timing scenarios depending on the availability of a common reference clock 150 for the two endpoints. However, the differential timing time stamp mechanism is used in both scenarios, and is explained next with reference to FIGS. 5-7.

FIG. 5 shows an arrangement of ingress node 500 with which a differential timing time stamp is added to each Ethernet frame 300. As shown, the CBR data stream 140 is received and may be stored in memory 520. The client clock 125, the frequency of which corresponds to the rate at which the CBR data stream 140 is being, e.g., clocked into memory 520, is supplied to counter A 515. The system reference clock 150 is supplied to counter B 525. The differential time stamp is generated as follows. In the beginning, suppose counter A 515 and counter B 525 are each zero. Each counter then begins counting in accordance with their respective inputs. When counter A 515 reaches a predetermined value (e.g., 256 in the instant example), the value of counter B 525, latched into latch counter 530, (e.g., 1000 for this first iteration) is used for the differential timing time stamp 470. This operation of counting, e.g., every 256 cycles, and capturing the value of the system reference clock 150 is repeated for every Ethernet frame 300. In the instant example, four consecutive Ethernet frames have the following DF time stamp values: 1000, 2000, 3001 and 4001. These values are listed in Table 1 below with their respective client clock counter values: 256, 512, 768, and 1024.

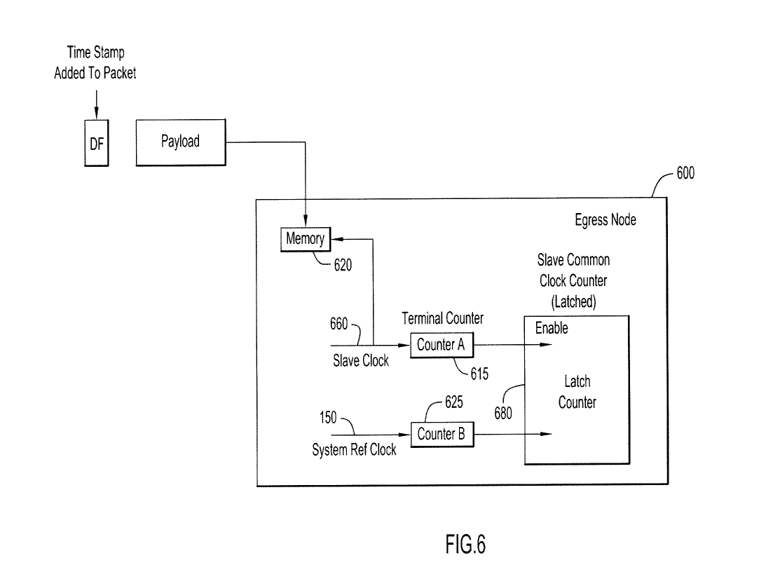

FIG. 6 and Table 1 below help to explain how the DF time stamp 470 is employed at egress node 600 to synchronize the slave clock 660 with client clock 125. Preliminarily, egress node 600 further comprises, as shown in FIG. 6, counter A 615, counter B 625 and a latch counter 680.

TABLE 1

| | Master | | | | | |
|---|---|---|---|---|---|---|
| | Information | | Slave Information | | | |
| | (Ingress Node) | | (Egress Node) | | | |
| | Client | DF (sys | Slave | | ActualSys | |
| | Clock | ref clock | clock | Target | ref clock | |
| Iteration | Counter | cycles) | Counter | value | cycles | Action |
| 1 | 256 | 1000 | 256 | 1000 | 1004 | Decrease |
| | | | | | | slave |
| | | | | | | clock |
| | | | | | | frequency |
| 2 | 512 | 2000 | 512 | 2000 | 2000 | none |
| 3 | 768 | 3001 | 768 | 3001 | 3001 | none |
| 4 | 1024 | 4001 | 1024 | 4001 | 3993 | Increase |
| | | | | | | slave |
| | | | | | | clock |
| | | | | | | frequency |

When an Ethernet packet 300 is received, the payload 401 including the DF time stamp 470 and control word 335 are stored in memory 620 of which queue 630 (see, e.g., FIG. 1) may be a part. The memory or queue may be implemented as, e.g., a first in, first out (FIFO) memory.

The egress node 600 knows how the DF time stamp value is determined (i.e., in this example: the number of system reference clock cycles for every n=256 client clock cycles), and with this knowledge the egress node 600 can control slave clock 660 based on the DF time stamp 470 (received from ingress node 500) and the system reference clock 150 (which is common for both nodes).

More specifically, the system reference clock 150 is the same for both nodes, so if during the same number of slave clock 660 cycles (counted by counter A 615), the same number of system reference clock 150 cycles are counted by counter B 625 (that is, the value that is stored as the DF time stamp), this means that the slave 660 frequency equals the client clock 125 frequency. If there is an inequality between the value of the DF time stamp 470 received with an Ethernet frame 300 and the value counted by counter B 625 and latched by latch counter 680, then the frequency of the slave clock 660 is adjusted.

Thus, referring to Table 1, if at iteration #1, where the number of system reference clock 150 cycles is greater than the DF time stamp value, then the slave clock 660 frequency is decreased. Similarly, where the number of system reference clock 150 cycles is less than the DF time stamp value at iteration #4, then the slave clock 660 frequency should be increased. In sum, at every iteration, i.e., after each receipt of an Ethernet frame 300 with a DF time stamp 470, a determination may be made as to whether the slave clock 660 properly matches the client clock 125 so that the CBR data stream 140 that has been encoded within the payload of the Ethernet frame can be accurately clocked out of packet to TDM module 670 (which might also be part of memory 620). Control of slave clock 660 may be implemented by adder 640.

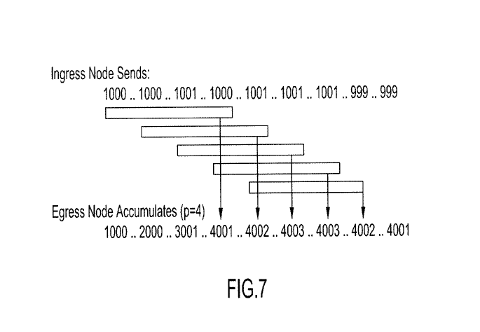

In an alternative embodiment shown in FIG. 7, ingress node 500 sends only the incremental values (that is 1000, 1000, 1001, 1000, . . . ) of the number of system reference clock 150 cycles. Egress node 600 accumulates these values in, e.g., a sliding window of p samples with p large enough to ensure accuracy. After p iterations, every time egress node 600 receives a new value, the oldest one is discarded.

As mentioned, the system reference clock 150 may not be available at the egress node 600. Thus, in a second embodiment, system reference clock information is fed through the network using the zero bit 331 of each fixed size data block 300.

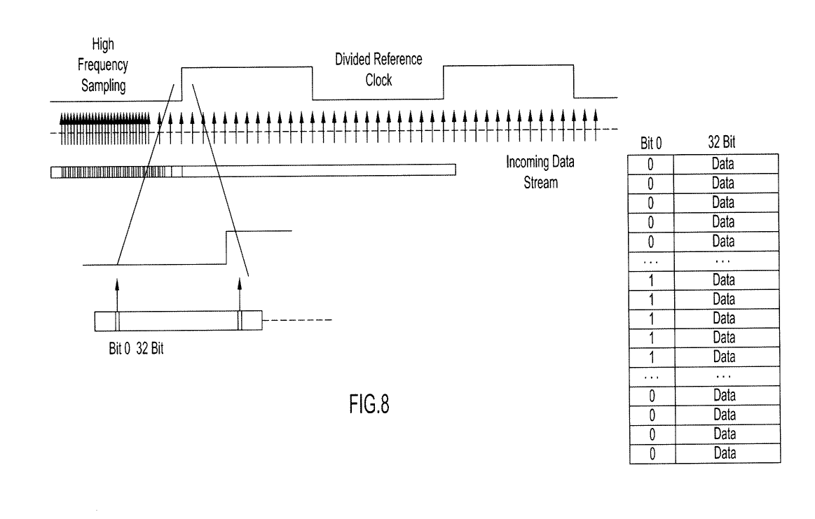

More specifically, and now with reference to FIG. 8, the data of CBR data steam 140, as noted, is assembled in units of 4 bytes (32 bits) plus 1 bit (the zero bit), such that there are a total of 32+1=33 bits/unit or block 330. A high speed clock is derived from the incoming data stream 140. The system reference clock 150 is divided down to obtain a low frequency copy thereof and sampled every 33 bits of the incoming video signal. The results of the sampling are stored in the zero bit 331 of each block 330 and transmitted toward the egress node 600.

The egress node 600 employs a counter (not shown, but which may be implemented within, e.g., adder 640) that averages zero bit values (e.g., the counter adds 1 if the zero bit value is 1, and subtracts 1 if the zero bit is 0). At every “t” clock cycles of slave clock 660, the value of the counter is evaluated to determine if the slave clock 660 is synchronous with client clock 125, where the accumulated average would be zero when synchronous. In the case where the difference is non-zero, a correction is applied to the regenerated system reference clock. The correction may be applied by adjusting the frequency of a voltage controlled oscillator (VCO) or the correction could be realized in the digital domain. By maintaining the average of the accumulated zero-bit values at or close to zero, a high quality reference clock can be synthesized such that the CBR data stream 140 can be clocked out of packet to TDM module 670 at the appropriate rate, namely the rate that matches the rate of the client clock 125. Thus, in sum, in this second embodiment, the synchronization of client clock 125 and slave clock 660 is effected in two steps including: first regenerating the system reference clock from the zero bit information from each fixed size block and then, second, synchronizing the slave clock 660 and the client clock 125 using the regenerated system reference clock.

As previously explained, forward error correction may be employed to better handle errors. Thus, even where a link, such as an optical link in packet switched network 100, might generate bit errors, the CBR data stream 140 that is encapsulated therein may nevertheless be transported error free due to the error correction capabilities of FEC.

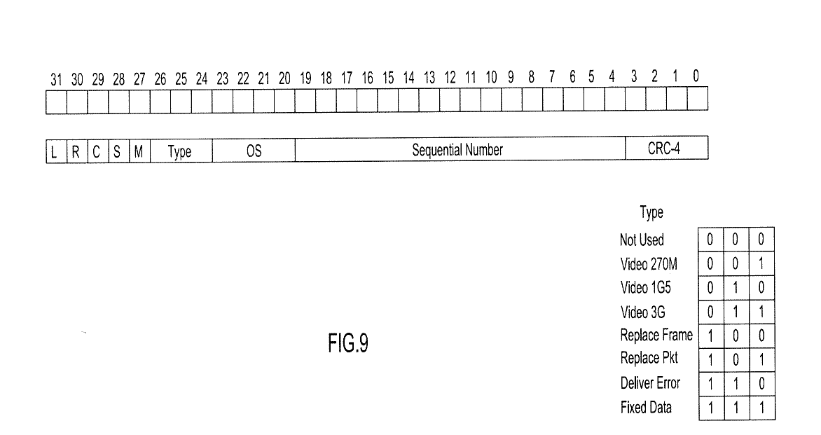

In any event, in the case of possible errors even after FEC correction, ingress node 500 can indicate to egress node 600, via the control word 335, what type of corrective action to take and can also supply other helpful information to the far end egress node 600. With reference to FIG. 9, the control word includes multiple fields, including L, R, C, S, M, Type, OS, Sequential Number, and CRC-4, along with the number of bits that may be assigned to each field. Each field is defined below.

L—when set, indicates an invalid payload due to failure of attachment circuit.

R—when set, indicates a remote error or failure.

C—when set, indicates a client signal failure.

S—when set, indicates a client signal failure (i.e., loss of character synchronization).

M—when set, indicates a main (versus protected) path. This field is used to differentiate data coming from different paths (main and protect) and is useful to avoid sending duplicated packets. For protection, the same traffic can be sent on a working path and on a protected path. Working and protected paths can be differentiated by this specific bit. A receiver can, based on the value of the M field, immediately ascertain that a stream is being received via a working or protected path.

The “type” field provides still additional information to the egress node 600. The type field identifies, for example, the kind of video that is being transported, as well as instructions regarding error correction techniques. Specifically, selected combinations of bits can indicate to the egress node 600 to replace a current frame with a last sent frame (here the egress node 600 would maintain in its memory a 2-video frame buffer, wherein frame n is kept stored and repeated in case frame n+1 has errors). Similarly, a code may be supplied to indicate to replace just an “errored” packet with the same packet of the previous frame. The code may also indicate to deliver a packet with a known error therein. And finally, the code may indicate to replace an errored packet with fixed data.

The OS field comprises four bits and is used to support optical automatic protection switching (e.g., failover or handover) by transporting K1/K2-like protocol for protection switching. Protection schemes rely on Near End and Far End nodes exchanging messages. These messages are usually transported in band (inside the packet). SONET defines two bytes called K1 and K2 to carry this message. Other bits may be defined to transport similar or other messages that enable the management of the protection scheme.

The sequential number may be used to re-order received fixed size blocks since the packet switched network 100 may deliver the frames 300 in a different order than may have been transmitted. Finally, the cyclical redundancy code helps to ensure the integrity of the data of the control word.

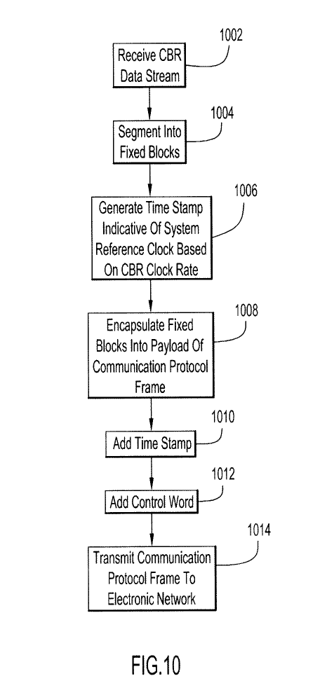

FIG. 10 is a flowchart of an example series of steps for processing, at an ingress node, a constant bit rate data stream and sending the same via a packet switched network. At step 1002 a CBR data stream is received. At step 1004 the CBR data stream is segmented into a plurality of fixed size blocks of data, e.g., 32 bits each (or 33 bits if the zero bit is employed). At step 1006, a time stamp indicative of a system reference clock is generated based on a local or client clock that is used to clock out the CBR data stream. Then, at step 1008, the fixed blocks of data are encapsulated into the payload of an electronic communication protocol frame, such as an Ethernet frame. At step 1010, the time stamp is also added to the payload, as is, at step 1012, a control word. At step 1014, the frame is transmitted to an electronic network, i.e., a packet switched network.

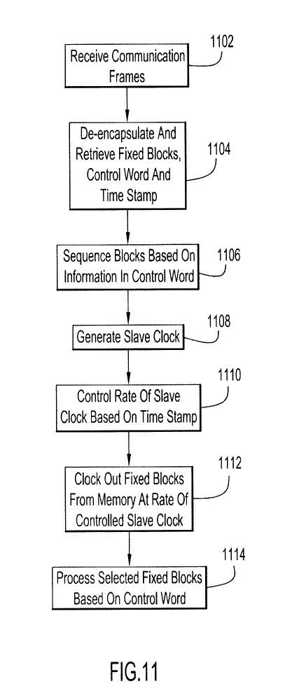

FIG. 11 is a flowchart of an example series of steps for recovering and processing, at an egress node, the constant bit rate data stream. At step 1102, the electronic communication protocol frame is received. At step 1104, the fixed blocks of data, control word and time stamp are de-encapsulated, and any errors corrected. At 1106, blocks from, perhaps different frames, are placed in a proper sequence (or at least pointed to in the proper sequence) based on a sequence number in the control word (blocks in the same frame are in the correct order (ordered bits are received at the ingress node), but packet order may be different at the egress node due to the fact that it is not guaranteed that packets flowing through a PSN arrive at the destination node with the transmission order). At step 1108, a slave clock is generated and, at step 1110, the slave clock is controlled based on the time stamp recovered from the electronic communication protocol frame. At step 1112, the data of the sequenced blocks is clocked out of memory at the rate of the controlled slave clock. Finally, at step 1114, selected fixed blocks may be specially processed based on information contained in the control word.

Although the system and method are illustrated and described herein as embodied in one or more specific examples, it is nevertheless not intended to be limited to the details shown, since various modifications and structural changes may be made therein without departing from the scope of the apparatus, system, and method and within the scope and range of equivalents of the claims. Accordingly, it is appropriate that the appended claims be construed broadly and in a manner consistent with the scope of the apparatus, system, and method, as set forth in the following.

What is claimed is:

1. A method comprising:
receiving a constant bit rate data stream;
segmenting the constant bit rate data stream into fixed size blocks of data;
generating a time stamp indicative of a system reference clock, the time stamp being in reference to a clock rate of the constant bit rate data stream;
encapsulating, in an electronic communication protocol frame, a predetermined number of fixed blocks of data along with (i) a control word indicative of, at least, a relative sequence of the predetermined number of fixed blocks of data in the constant bit rate stream and (ii) the time stamp; and
transmitting the electronic communication protocol frame to a packet switched network.

2. The method of claim 1, wherein the constant bit rate stream comprises video data.

3. The method of claim 1, wherein the fixed block size is 32 bits.

4. The method of claim 3, further comprising appending a timing bit to each fixed size block of data.

5. The method of claim 4, further comprising setting the timing bit based on a value of the system reference clock at a selected interval of a client clock that clocks out the constant bit rate data stream.

6. The method of claim 1, wherein the control word provides instructions to an egress node regarding how to process data received in the payload of the electronic communication protocol frame.

7. The method of claim 1, wherein the electronic communication protocol frame is an Ethernet frame.

8. A method comprising:
receiving, via a packet switched network, an electronic communication protocol frame having encapsulated therein a predetermined number of fixed blocks of a constant bit rate data stream along with (i) a control word indicative of, at least, a relative sequence of the predetermined number of fixed blocks of data in the constant bit rate data stream and (ii) a time stamp;
storing the fixed blocks of the constant bit rate data stream in memory;
generating a slave clock that is controlled at least in part based on the time stamp;
clocking out from the memory the constant bit rate data stream data using the slave clock; and
processing selected fixed blocks of the constant bit rate data stream data using information from the control word.

9. The method of claim 8, wherein generating the slave clock comprises comparing a number of system reference clock cycles counted over a predetermined number of slave clock cycles to the time stamp.

10. The method of claim 8, wherein the fixed block size is 32 bits.

11. The method of claim 10, further comprising analyzing a timing bit appended to each fixed size block of data.

12. The method of claim 11, further comprising re-creating a system reference clock based on a value of the timing bit.

13. The method of claim 8, wherein the electronic communication protocol frame is an Ethernet frame.

14. An apparatus comprising:
a processor; and
a memory;
the processor being configured to
segment a constant bit rate data stream into fixed size blocks of data that is stored in the memory;
generate a time stamp indicative of a system reference clock, the time stamp being in reference to a clock rate of the constant bit rate data stream;
encapsulate, in an electronic communication protocol frame, a predetermined number of fixed size blocks of data along with (i) a control word indicative of, at least, a relative sequence of the predetermined number of fixed size blocks of data in the constant bit rate stream and (ii) the time stamp; and
cause the electronic communication protocol frame to be transmitted into a packet switched network.

15. The apparatus of claim 14, wherein the processor is further configured to cause a timing bit to be appended each fixed size block of data.

16. The apparatus of claim 15, wherein the timing bit is based on a value of the system reference clock at a selected time interval of the clock rate of the constant bit rate data stream.

17. The apparatus of claim 14, wherein the electronic communication protocol frame is an Ethernet frame.

18. An apparatus comprising:
a processor; and
a memory,
the processor being configured to
receive, via a packet switched network, an electronic communication protocol frame having encapsulated therein a predetermined number of fixed blocks of a constant bit rate data stream data along with (i) a control word indicative of, at least, a relative sequence of the predetermined number of fixed blocks of data in the constant bit rate data stream and (ii) a time stamp;
cause the fixed blocks of the constant bit rate data stream to be stored in memory;
control a rate of the slave clock based on the time stamp;
cause the constant bit rate data stream data to be clocked out from the memory using the slave clock; and
process selected fixed blocks of the constant bit rate data stream data using information from the control word.

19. The apparatus of claim 18, wherein the processor is further configured to control a rate of the slave clock by comparing a number of system reference clock cycles counted over a predetermined number of slave clock cycles to the time stamp.

20. The apparatus of claim 18, wherein the electronic communication protocol frame is an Ethernet frame.
